(19) United States
(12) Patent Application Publication
(10) Pub. No.: US 2002/0120938 A1
(43) Pub. Date: Aug. 29, 2002

(54) Decoder and partaker union device

(76) Inventor: Shih-Tsung Huang, Gia Yi (TW)

Correspondence Address: Alan Kamrath, RIDER BENNETT EGAN & ARUNDEL, LLP, Suite 2000, 333 South Seventh Street, Minneapolis, MN, 55402, US

(21) Appl. No.: 09/795,564

(22) Filed: Feb. 28, 2001

(51) Int. Cl. H04N 7/18; H04N 7/173; H04N 7/00; H04N 11/00

(52) U.S. Cl. 725/80; 348/552; 725/132

(57) ABSTRACT

A decoder and partaker union device has a decoder, a first partaker, and a coaxial cable connected to the decoder and the first partaker. The decoder has a first radio frequency output terminal, a first frequency mixer, a first breaker, a second radio frequency output terminal, a first remote-control receiving detector, and an integrated circuit control board. The first partaker has a second radio frequency output terminal, a second breaker, a second frequency mixer, a first radio frequency input terminal, a third remote-control receiving detector, and a first power supply device.

### BACKGROUND OF THE INVENTION

The present invention relates to a decoder and partaker union device for television sets.

A conventional decoder is suitable for a television set only. If more than two television sets are placed in a house, each television set needs a decoder.

### SUMMARY OF THE INVENTION

An object of the present invention is to provide a decoder and partaker union device which has a decoder for a first television set and a partaker for a second television set. Therefore, more than two television sets need a single decoder only.

Accordingly, a decoder and partaker union device comprises a decoder, a first partaker, and a coaxial cable connected to the decoder and the first partaker. The decoder is connected to a first television set. The first partaker is connected to a second television set.

### BRIEF DESCRIPTION OF THE DRAWINGS

FIG. 1 is an electric diagram of a decoder and partaker union device of a preferred embodiment in accordance with the present invention;

FIG. 2 is a perspective view of a decoder and partaker union device of a preferred embodiment connected to two television sets; and

FIG. 3 is an electric diagram of a decoder and partaker union device which has a first partaker and a second partaker.

### DETAILED DESCRIPTION OF THE INVENTION

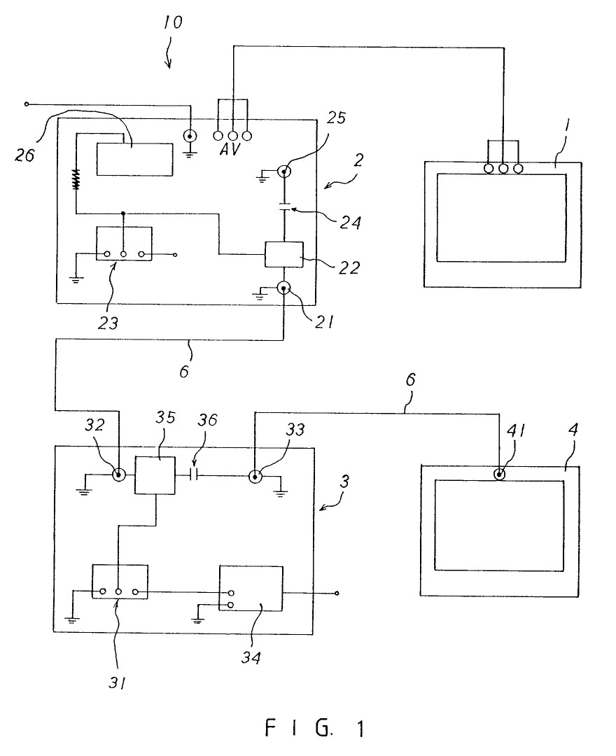

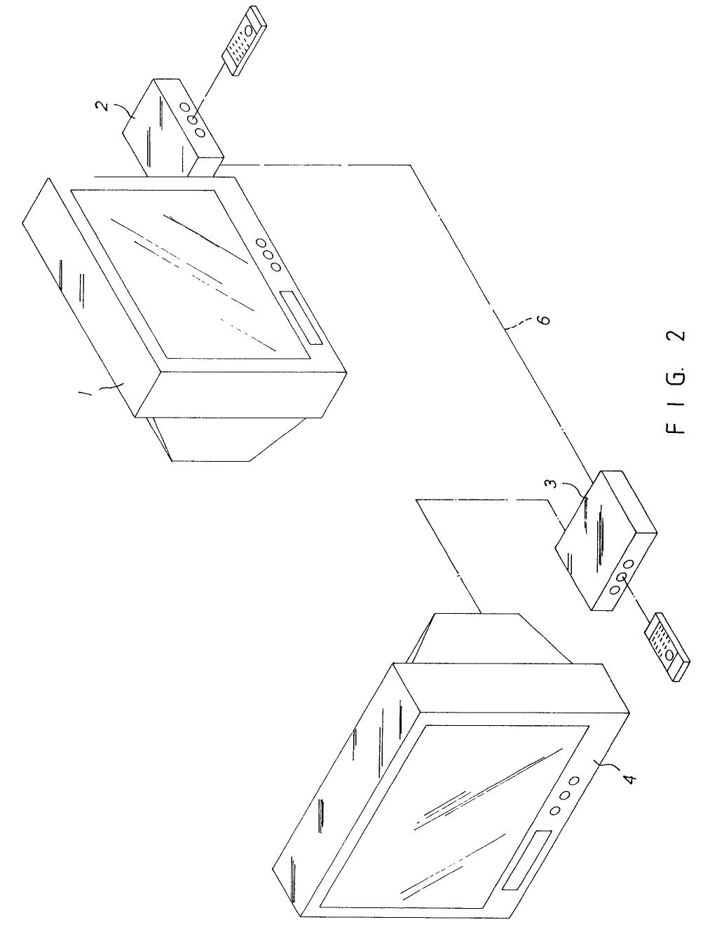

Referring to FIGS. 1 and 2, a decoder and partaker union device 10 comprises a decoder 2, a first partaker 3, and a coaxial cable 6 connected to the decoder 2 and the first partaker 3.

The decoder 2 has a first radio frequency output terminal 21, a first frequency mixer 22, a first breaker 24, a second radio frequency output terminal 25, a first remote-control receiving detector 23, and an integrated circuit control board 26.

The first frequency mixer 22 is connected to the first radio frequency output terminal 21, the first breaker 24, and the first remote-control receiving detector 23.

The first breaker 24 is connected to the second radio frequency output terminal 25.

The first partaker 3 has a second radio frequency output terminal 33, a second breaker 36, a second frequency mixer 35, a first radio frequency input terminal 32, a second remote-control receiving detector 31, and a first power supply device 34.

The second frequency mixer 35 is connected to the second breaker 36, the first radio frequency input terminal 32, and the second remote-control receiving detector 31.

The second radio frequency output terminal 33 is connected to the second breaker 36.

The second remote-control receiving detector 31 is connected to the first power supply device 34.

The decoder 2 is connected to a first television set 1.

The first partaker 3 is connected to a second television set 4.

The second television set 4 has a second radio frequency input terminal 41.

Another coaxial cable 6 is connected to the third radio frequency output terminal 33 and the second radio frequency input terminal 41.

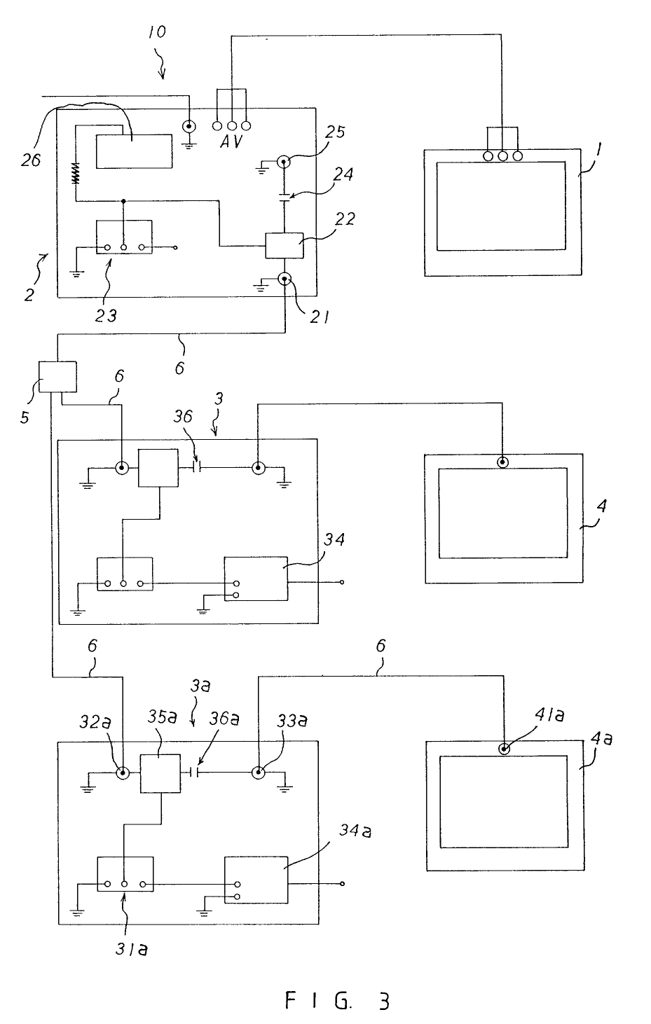

Referring to FIG. 3, an additional partaker 3a is connected to the first partaker 3.

The additional partaker 3a has a fourth radio frequency output terminal 33a, a third breaker 36a, a third frequency mixer 35a, a third radio frequency input terminal 32a, a third remote-control receiving detector 31a, and a second power supply device 34a.

The third frequency mixer 35a is connected to the third breaker 36a, the third radio frequency input terminal 32a, and the third remote-control receiving detector 31a.

The fourth radio frequency output terminal 33a is connected to the third breaker 36a.

The third remote-control receiving detector 31a is connected to the second power supply device 34a.

The second partaker 3a is connected to a third television set 4a.

The third television set 4a has a fourth radio frequency input terminal 41a.

A third coaxial cable 6 is connected to the fourth radio frequency output terminal 33a and the fourth radio frequency input terminal 41a.

A distributor 5 is connected to the first radio frequency output terminal 21, the first radio frequency input terminal 32, and the third radio frequency input terminal 32a.

The invention is not limited to the above embodiment but various modification thereof may be made. Further, various changes in form and detail may be made without departing from the scope of the invention.

I Claim:

1. A decoder and partaker union device comprises:
a decoder, a first partaker, and a coaxial cable connected to the decoder and the first partaker,
wherein the decoder is connected to a first television set, and the first partaker is connected to a second television set.

2. The decoder and partaker union device as claimed in claim 1, wherein the decoder has a first radio frequency output terminal, a first frequency mixer, a first breaker, a second radio frequency output terminal, a first remote-control receiving detector, and an integrated circuit control board, the first frequency mixer is connected to the first radio frequency output terminal, the first breaker, and the first remote-control receiving detector, and the first breaker is connected to the second radio frequency output terminal.

3. The decoder and partaker union device as claimed in claim 1, wherein the first partaker has a second radio frequency output terminal, a second breaker, a second frequency mixer, a first radio frequency input terminal, a second remote-control receiving detector, and a first power supply device, the second frequency mixer is connected to the second breaker, the first radio frequency input terminal, and the second remote-control receiving detector, the second radio frequency output terminal is connected to the second breaker, and the second remote-control receiving detector is connected to the first power supply device.
